(19) United States
(12) Patent Application Publication
(10) Pub. No.: US 2003/0127875 A1
(43) Pub. Date: Jul. 10, 2003

(54) Truck bed extension rails

(76) Inventor: Ron Hornick, Hartwell, GA (US)

Correspondence Address: Richard C. Litman, LITMAN LAW OFFICES, LTD., P.O. Box 15035, Arlington, VA, 22215, US

(21) Appl. No.: 10/336,009

(22) Filed: Jan. 3, 2003

Related U.S. Application Data
(60) Provisional application No. 60/346,392, filed on Jan. 9, 2002.

(51) Int. Cl. B62D 33/023

(52) U.S. Cl. 296/32; 296/36

(57) ABSTRACT

A pair of rails that are movable from a collapsed position to an extended position and function to increase the cargo-carrying volume and stability of a pick-up truck bed. The rails are mounted on rods which are mounted for vertical movement. In the collapsed position, the rods are nested between the outer and inner walls of the truck bed. Similar structure is provided for the tailgate. The rods are provided with vertically spaced apertures so that the cargo may be safely tied down. A wall may be attached to each rail so that the truck bed will be laterally enclosed when the rails are in an extended position. A detachable canopy is provided to span the rails and enclose the top of the bed.

### CROSS-REFERENCE TO RELATED APPLICATION

This application claims the benefit of U.S. Provisional Patent Application Serial No. 60/346,392, filed Jan. 9, 2002.

### BACKGROUND OF THE INVENTION

1. Field of the Invention

The present invention generally relates to motor vehicle bodies. More specifically, the present invention is drawn to structure for increasing the cargo-carrying volume of a pick-up truck.

2. Description of Related Art

Once relegated to rural use, the pick-up truck has gained acceptance as utility vehicle for use by homeowners in both suburban and urban areas. The pick-up truck is commonly utilized to haul furniture, fireplace logs, trash, etc.

However, the safe hauling capacity of the truck is limited by the height of the tailgate and sidewalls of the pick-up bed. It is not uncommon for users to overload and pile cargo high above the sidewalls and tailgate of the bed. It is also not uncommon to see portions of the cargo spilled from the overloaded bed and strewn on the streets and freeways, thereby creating hazardous driving conditions. An efficient and aesthetic apparatus to increase the cargo-carrying capacity of the pick-up bed would certainly be a welcome addition to the art.

There is a plethora of prior art devices for increasing the capacity of a pick-up truck bed. For example, U.S. Pat. No. 2,711,342 (Selzer), U.S. Pat. No. 4,423,899 (Langmead), U.S. Pat. No. 4,585,264 (Miller) and U.S. Pat. No. 4,703,969 (Rayburn et al.) disclose upright extensions for truck beds. It is noted that the disclosed extensions must be mounted and unmounted from the sidewalls of the truck bed.

U.S. Pat. No. 3,841,690 (Piercy), U.S. Pat. No. 5,037,152 (Hendricks), U.S. Pat. No. 5,152,570 (Hood) and McDaniel U.S. Pat. No. 5,190,337 show extensions which are collapsed in the bed or on the sidewalls of the truck. All the extensions can be readily viewed in their collapsed state, thereby detracting from the aesthetics of the pick-up truck.

U.S. Pat. No. 3,891,262 (Brunel), U.S. Pat. No. 5,431,472 (Coffland), U.S. Pat. No. 5,494,327 (Derecktor) and U.S. Pat. No. 5,836,635 (Dorman) are drawn to collapsible overhead rack structure for pickup trucks.

The collapsible rack structure is not hidden from view in the collapsed state.

U.S. Pat. No. 5,924,753 (DiBassie) discloses structure for horizontally extending the truck bed capacity.

U.S. Pat. No. 6,227,592 B1 shows a collapsible frame for a pick-up bed cover. The frame is designed to be attached to the inner sidewalls of the bed, thereby utilizing a portion of the available cargo capacity.

U.S. Pat. No. 3,694,024 (Linville) and U.S. Pat. No. 4,392,682 (Norkus) disclose telescoping structure for vertically expanding the capacity of a cargo truck trailer. The instant structure is pertinent to large-size commercial trailers. Such structure would not be readily adaptable to a pick-up truck.

None of the above inventions and patents, taken either singly or in combination, is seen to disclose collapsible truck bed extension rails as will be subsequently described and claimed in the instant invention.

### SUMMARY OF THE INVENTION

The instant invention is drawn to rails which are movable from a collapsed position to an extended position and function to increase the cargo-carrying volume and stability of a pick-up truck bed. The rails are mounted on rods which are mounted for vertical movement. In the collapsed position, the rods are nested between the outer and inner walls of the truck bed. Similar structure is provided for the tailgate and may be provided at the rear of the truck cab. The rods are provided with vertically spaced apertures so that the cargo may be safely tied down. A wall may be attached to each rail so that the truck bed will be laterally enclosed when the rails are in an extended position. A canopy is provided to span the rails and enclose the top of the bed.

Accordingly, it is a principal object of the invention to provide structure for increasing the cargo-carrying capacity of the bed of a pick-up truck.

It is another object of the invention to provide structure for increasing the cargo-carrying capacity of the bed of a pickup up truck, which structure can be collapsed when not in use.

It is a further object of the invention to provide structure for increasing the cargo-carrying capacity of the bed of a pick-up truck, which structure is concealed when in a collapsed position.

Still another object of the invention is to provide structure for increasing the cargo-carrying capacity of the bed of a pick-up truck, which structure includes walls for enclosing the perimeter of the bed.

It is an object of the invention to provide improved elements and arrangements thereof in an apparatus for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a truck bed extension railing according to the present invention.

FIG. 2 is a partial, perspective view of a truck bed extension railing in a retracted position according to the present invention.

FIG. 3 is a partial, perspective view of a truck bed extension railing in an extended position according to the present invention.

FIG. 4 is a partial, perspective view of an extension railing for a tailgate according to the present invention.

FIG. 5 is a side view of a second embodiment of an extension railing in a retracted position according to the present invention.

FIG. 6 is a side view of a second embodiment of an extension railing in an extended position according to the present invention.

FIG. 7 is a partial, end view of a third embodiment of a truck bed extension railing according to the present invention.

FIG. 8 is a partial, end view of a fourth embodiment of a truck bed extension railing according to the present invention.

FIG. 9 is a partial, perspective view including a cargo dome attached to the railing according to the present invention.

FIGS. 10A-10D are partial views of various structures utilized for locking the railing in an extended position according to the present invention.

Similar reference characters denote corresponding features consistently throughout the attached drawings.

### DETAILED DESCRIPTION OF THE PREFERRED EMBODIMENTS

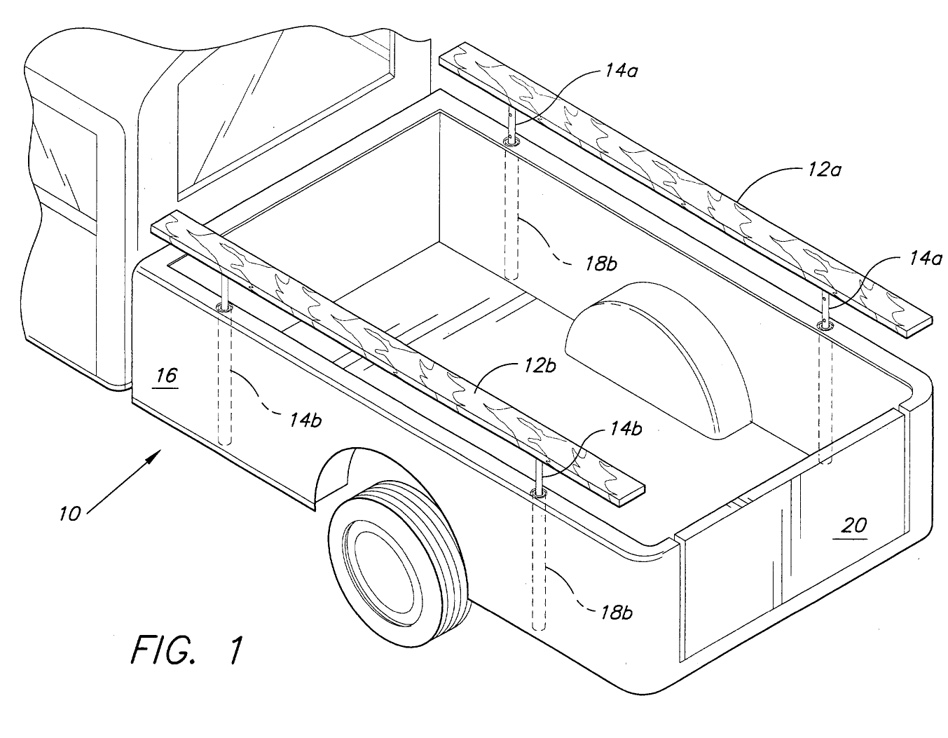

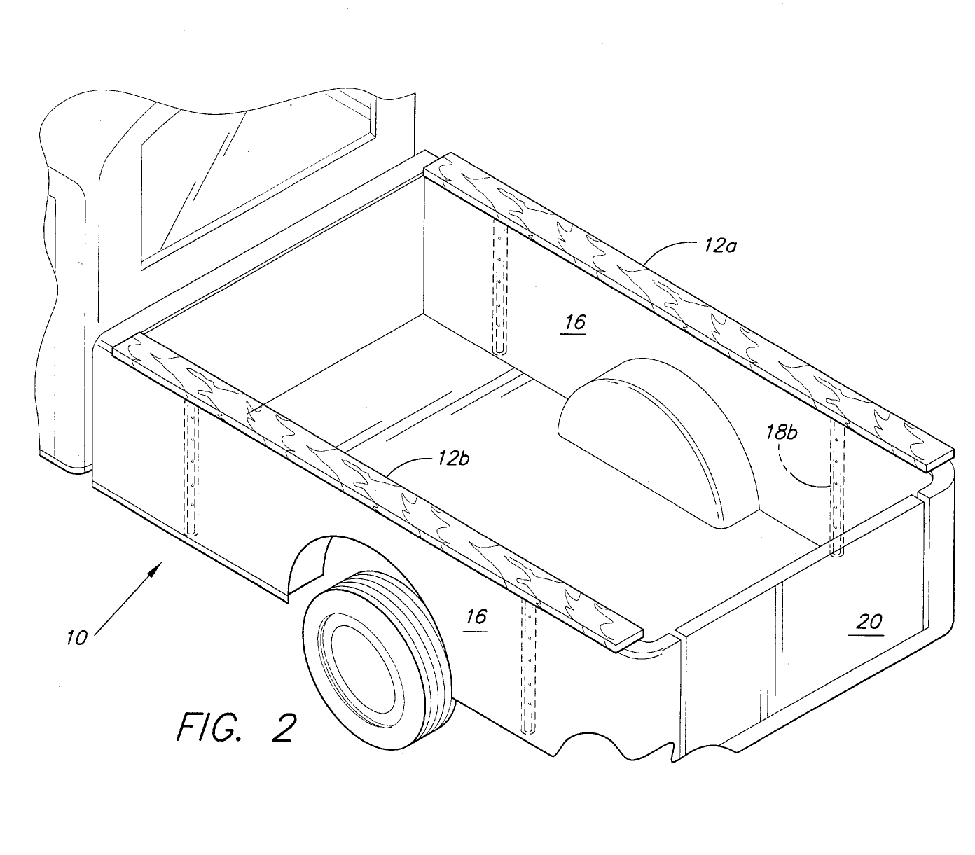

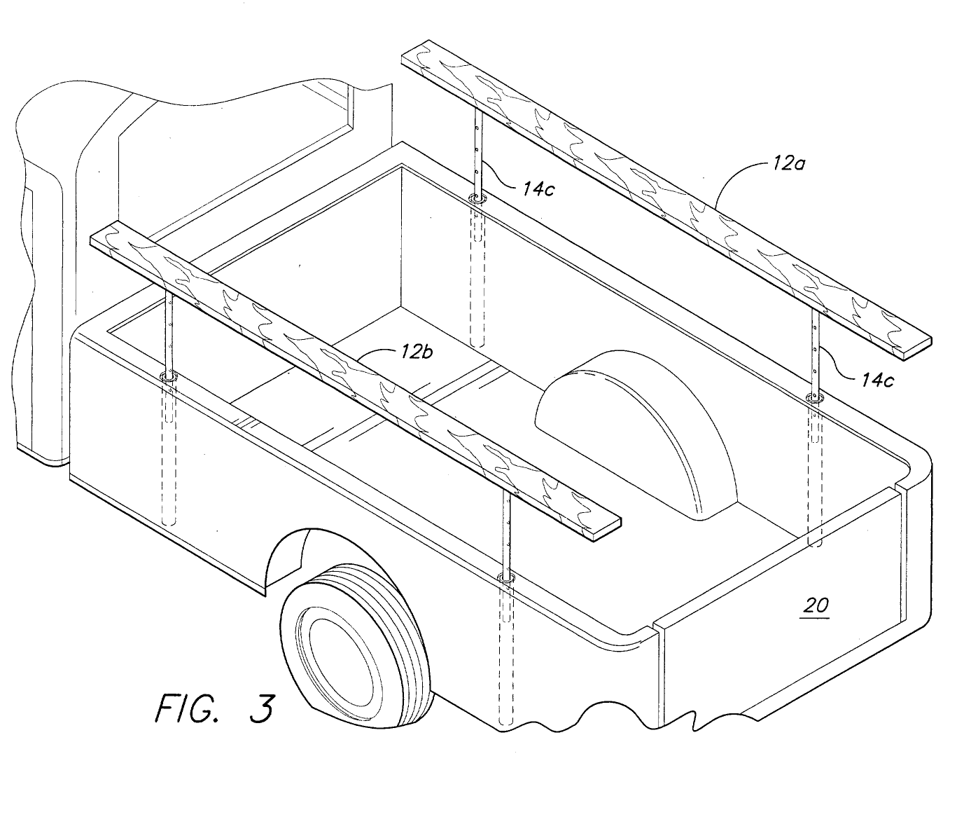

Attention is directed to FIGS. 1-3 wherein a first embodiment of the extension railing of the present invention is mounted on the bed of a pick-up truck generally indicated at 10. The extension railing comprises a pair of rails 12a, 12b mounted on tubular members 14a, 14b. Rails 12a, 12b are substantially coextensive with the sidewalls 16 of the pick-up truck and are designed to fit flush with the top of the sidewalls when the rails are in a retracted position (FIG. 2). As contemplated, the rails will be fabricated from the same material as the sidewalls and will be of a similar or complimentary color. Further, the rails may be configured to assume the contour of the sidewalls so that a pleasing aesthetic effect is presented. Tubular members 14a, 14b are telescopically mounted in members 18a, 18b disposed in the fender well between the inner and outer walls of sidewalls 16. As indicated above, when extended (FIGS. 1 and 3), the rails provide an increased cargo-carrying capacity for the pick-up bed. In the retracted position (FIG. 2), the rails fit flush with the sidewalls of the truck and are substantially indistinguishable from the sidewalls. An array of openings 14c is provided in members 14a, 14b so that cargo may be tied down with ropes or the like if necessary.

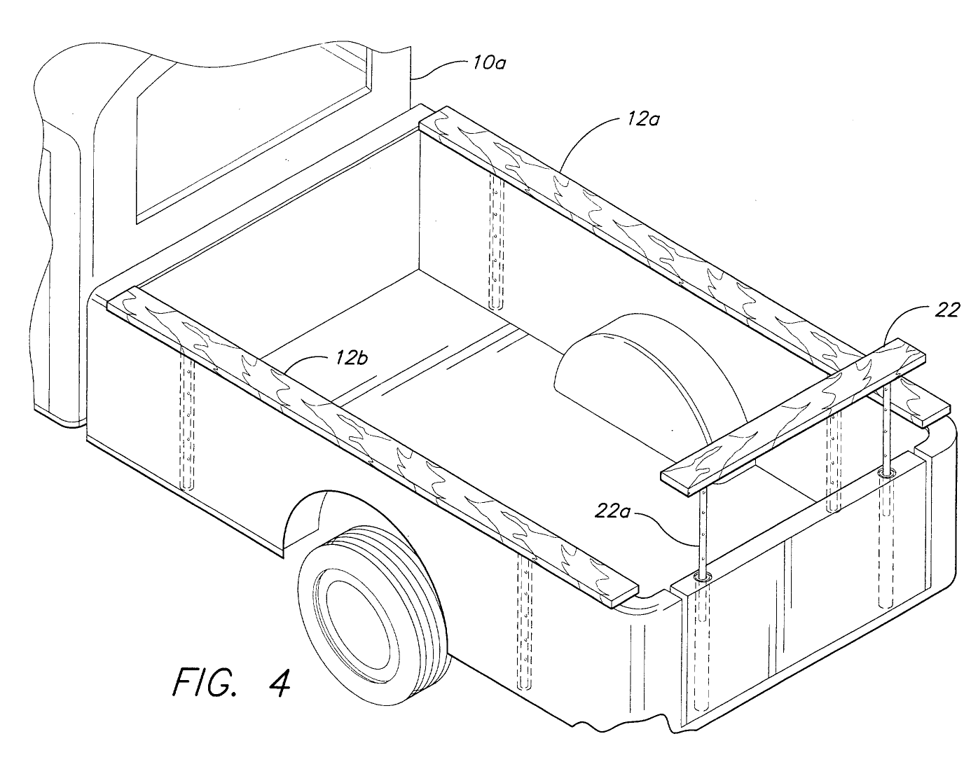

In FIG. 4, the instant invention is adapted to the tailgate 20 of pick-up truck 10. As illustrated, rail 22 is mounted on members 22a. Members 22b are disposed between the walls of tailgate 20 for telescopically receiving members 22a. As described above, rail 22 will be fabricated from the same material as the tailgate and may be designed to assume the same configuration as the tailgate. It is obvious that a similar rail system could be disposed adjacent the rear of the truck cab 10a if desired.

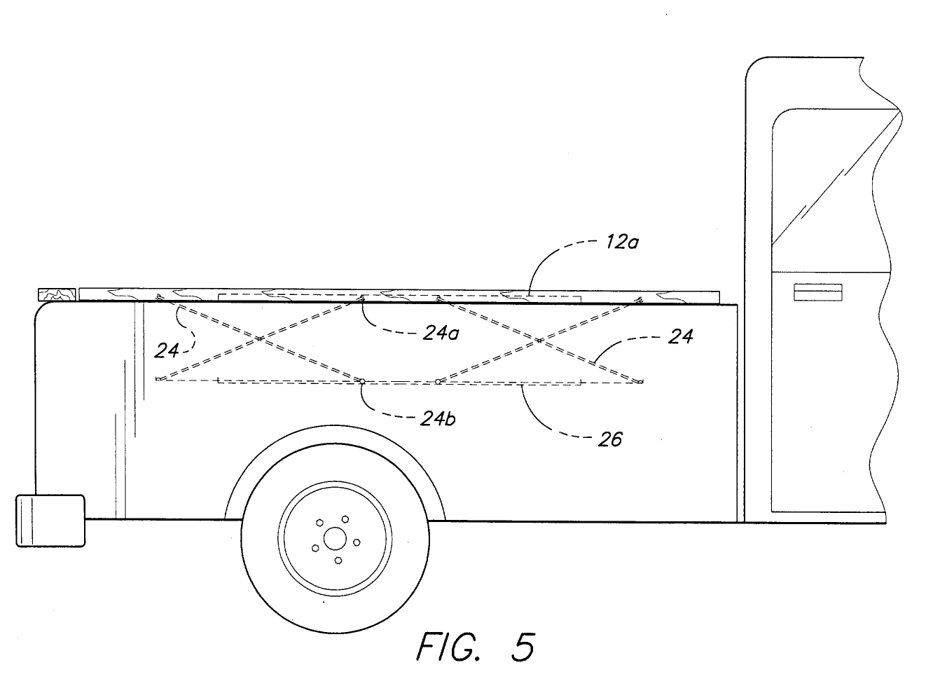

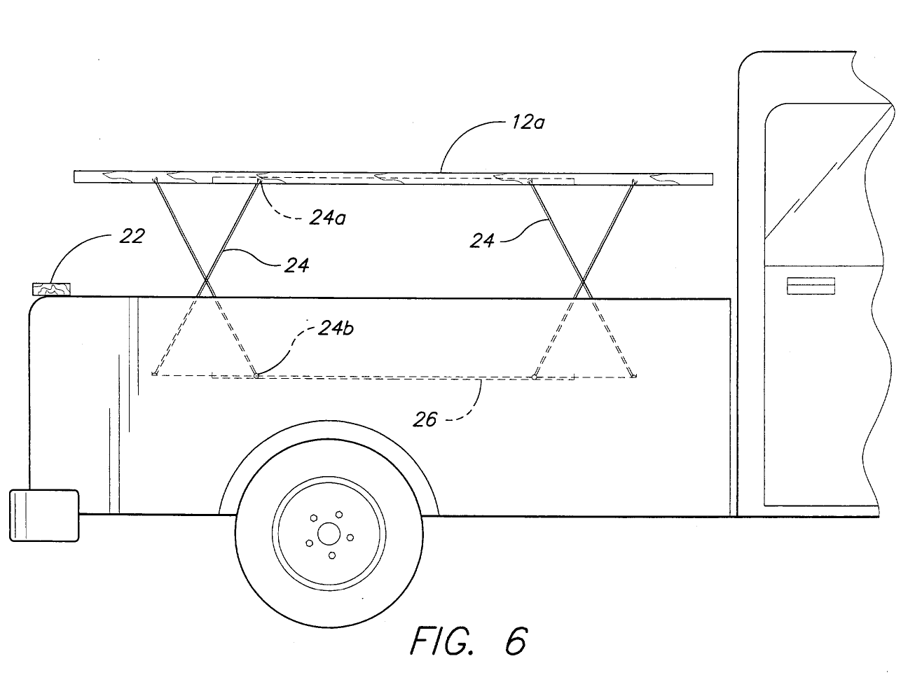

FIGS. 5 and 6 are illustrative of an alternative rail support system that employs scissored legs 24. Legs 24 have first ends 24a in sliding attachment to a track on the underside of rail 12a. Second ends 24b are secured for sliding movement in track 26. Track 26 is disposed between the inner and outer walls of the truck sidewall 16. Rail 12b is supported in like manner. Legs 24 are completely hidden from view when the rail is in a retracted position (FIG. 5). Although not shown, it is noted that legs 24 will be provided with openings similar to those as shown at 14c to tie down the cargo when the rail is in an extended position (FIG. 60).

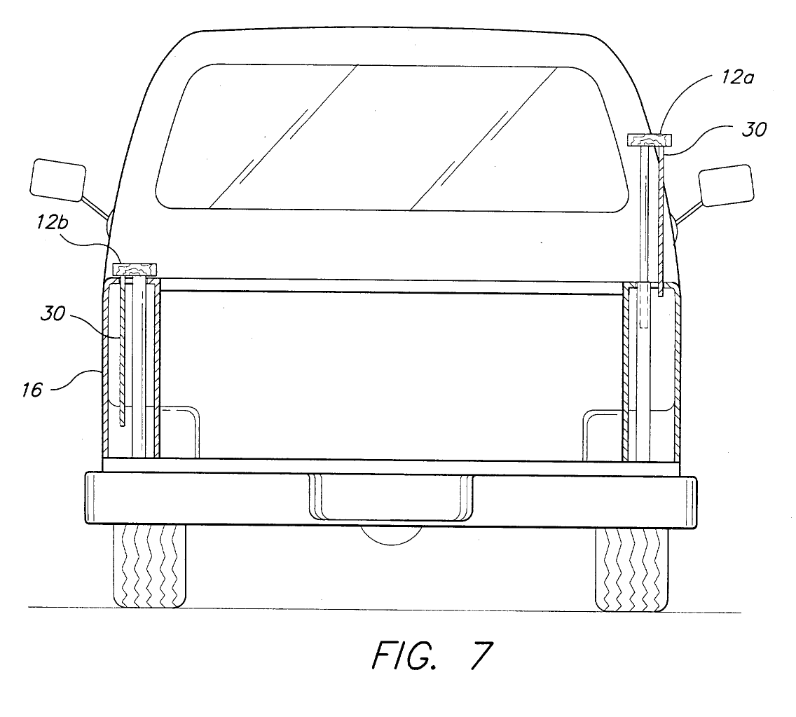

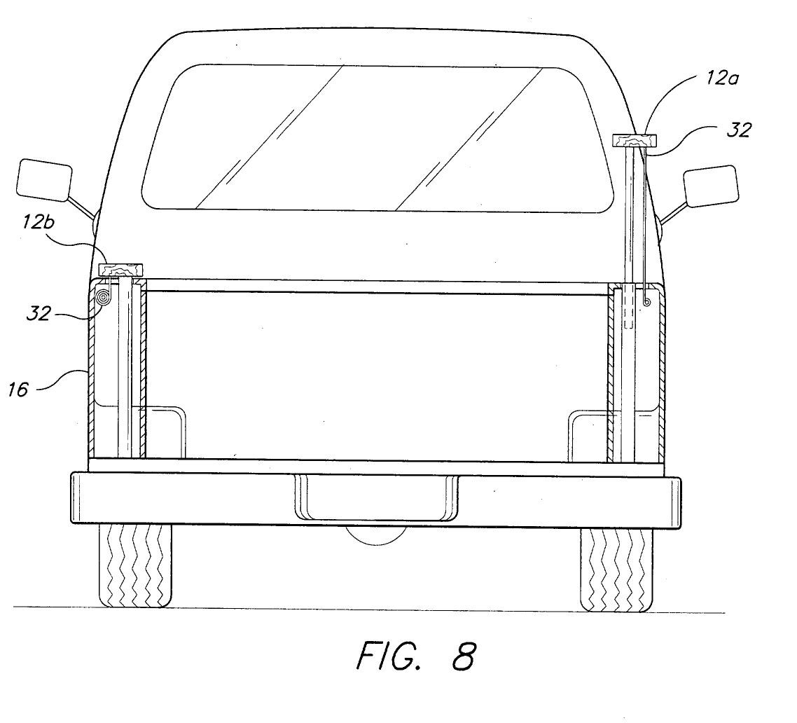

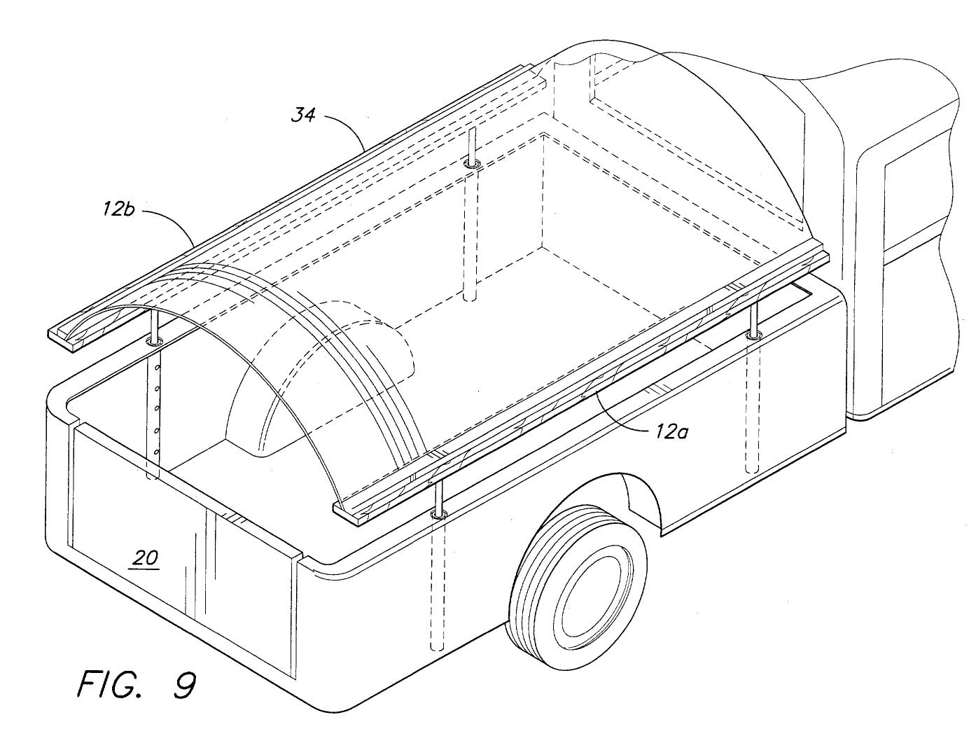

It is often desired to protect the hauled cargo from the elements such as rain and/or snow. The embodiments of the invention as illustrated in FIGS. 7-9 will allow a user to accomplish such protection. In FIGS. 7 and 8 walls 30 and 32 are affixed to the underside of rails 12a, 12b. Wall 30 is fabricated as a flat sheet that is nested between the inner and outer walls of sidewall 16. Wall 32 is designed is fabricated in a scroll design and is also nested between the inner and outer walls of sidewall 16. When the rails are in an extended position, walls 30, 32 will provide a shield on the sides of the truck bed. The wall structure may also be incorporated in the tailgate to protect the rear end of the bed from the elements. FIG. 9 illustrates a protective canopy 34 that is positioned to span the top of the truck bed. Canopy 34 may be detachably mounted to rails 12a, 12b in any conventional and efficient fashion. Walls 30, 32 and canopy 34 may be fabricated from any suitable and durable material (sheet metal, canvas, etc.).

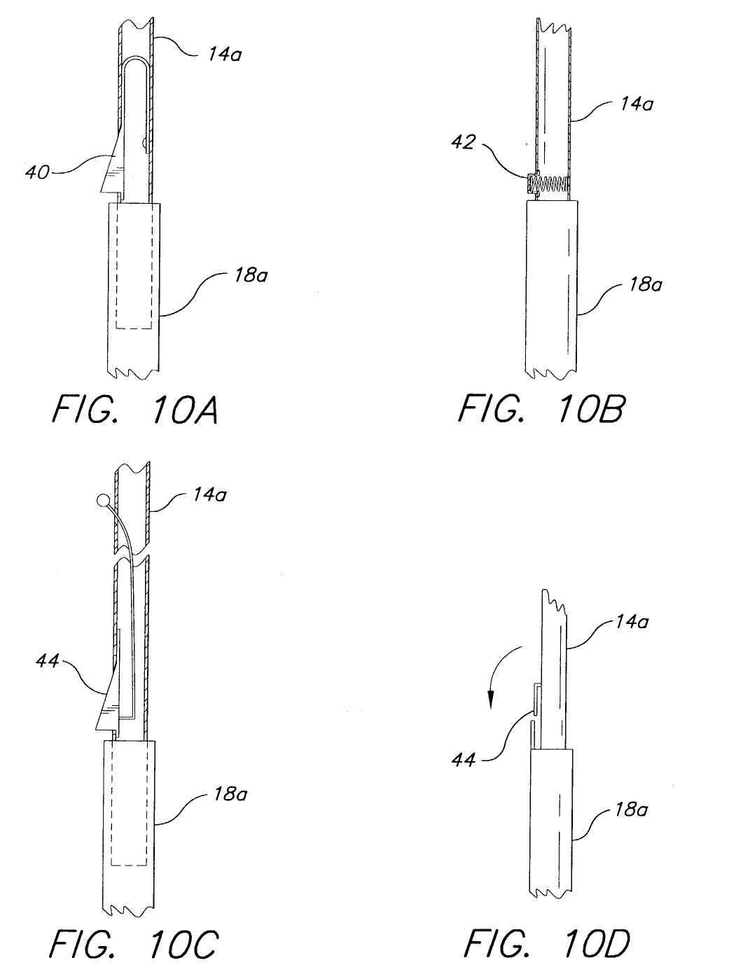

FIG. 10 is illustrative of some of the conventional means that may be employed to secure the rail system in an extended position and to also provide for quick release when it is desired to collapse the system. Leaf spring clip 40, push button clip 42, pull spring clip 44 and overlap clip 46 are respectively shown in FIGS. 10A-D and represent a few of the many suitable and conventional means which may be employed to secure members 14a, 14b in their extended positions.

It is recognized that smaller pick-up trucks are sometimes not provided with hollow sidewalls and employ only a single wall. In such cases, the instant invention contemplates providing an insert to fit into the truck bed which may be bolted or clipped to the single wall and form a smooth inside wall. The rail system of the above invention can be adapted to be mounted in the insert.

It is to be understood that the present invention is not limited to the sole embodiments described above, but encompasses any and all embodiments within the scope of the following claims.

I claim:

1. In combination with a pick-up truck bed, said truck bed having at least one hollow sidewall, an assembly for increasing the volumetric cargo space of the bed comprising:
a first plurality of rod members, said plurality of rod members telescopically disposed in said hollow sidewall for movement from a retracted position to an extended position;
at least one rail member, said rail member being coextensive with said sidewall and attached to said plurality of rod members; and
means for securing said rod members in said extended position.

2. The combination as recited in claim 1, including an array of apertures disposed in said first plurality of rod members.

3. The combination as recited in claim 1, including a tail gate disposed on said truck bed, said tail gate having hollow walls;
a second plurality of rod members telescopically disposed in said hollow walls;
a rail member, said rail member being coextensive with said tail gate and attached to said second plurality of rod members.

4. The combination as recited in claim 3, including an array of apertures disposed in said second plurality of rod members.

5. The combination as recited in claim 4, wherein said means for securing includes leaf spring clips disposed on said first and said second plurality of rod members.

6. The combination as recited in claim 4, wherein said means for securing includes push button clips disposed on said first and said second plurality of rod members.

7. The combination as recited in claim 4, wherein said means for securing includes pull spring clips disposed on said first and said second plurality of rod members.

8. The combination as recited in claim 4, wherein said means for securing includes overlap clips disposed on said first and said second plurality of rod members.

9. In combination with a pick-up truck bed, said truck bed having a pair of spaced, parallel hollow sidewalls, an assembly for increasing the volumetric cargo space of the bed comprising:
a first plurality of rod members, said plurality of rod members telescopically disposed in said pair of hollow sidewalls for movement from a retracted position to an extended position;
a pair of rail members, each rail member being coextensive with a respective one of said hollow sidewalls and each rail member having an underside attached to respective ones of said plurality of rod members;
a pair of wall members, each wall member attached to the underside of a respective rail member, each wall member being coextensive with said respective hollow sidewalls and nested within said hollow sidewalls when said rod members are in said retracted position; and
means for securing said rod members in said extended position.

10. The combination as recited in claim 9, including a canopy spanning said pair of spaced, parallel hollow sidewalls.

11. The combination as recited in claim 10, wherein said wall members are flat panels.

12. The combination as recited in claim 10, wherein said wall members are fabricated as scrolls.

13. In combination with a pick-up truck bed, said truck bed having at least one hollow sidewall, an assembly for increasing the volumetric cargo space of the bed comprising:
a plurality of scissored leg members, each scissored leg member having first ends and second ends, said scissored leg members nested within said hollow sidewall for movement from a retracted position to an extended position;
at least one rail member, said rail member having an underside and being coextensive with said sidewall;
a first track member, said first track member disposed within said hollow sidewall;
a second track member, said second track member disposed on the underside of said rail member; and
means for securing said scissored leg members in said extended position.

14. The combination as recited in claim 13, wherein said first ends of said scissored leg members are in sliding engagement with said first track member.

15. The combination as recited in claim 14, wherein said second ends of said scissored leg members are in sliding engagement with said second track member.

16. The combination as recited in claim 13, including an array of apertures disposed in said plurality of scissored leg members.
